(19) United States
(12) Patent Application Publication
(10) Pub. No.: US 2024/0397172 A1
(43) Pub. Date: Nov. 28, 2024

(54) CAMERA MODULE

(71) Applicant: DENSO CORPORATION, Kariya-city (JP)

(72) Inventor: Kiwako TAKEZAWA, Kariya-city (JP)

(21) Appl. No.: 18/672,841

(22) Filed: May 23, 2024

(30) Foreign Application Priority Data
May 25, 2023 (JP) 2023-086323

(51) Int. Cl. H04N 23/51; H04N 23/52; H04N 23/55

(52) U.S. Cl. CPC H04N 23/51; H04N 23/52; H04N 23/55

(57) ABSTRACT

In a camera module, a casing has electrical conductivity and is joined to a holder. A cover has electrical conductivity. At least one fastening member fastens the casing and the cover to each other, an assembly of the casing and cover accommodating at least an imaging device and a board. The casing includes at least one abutment portion arranged to abut onto the cover while the cover is fastened to the casing by the at least one fastening member. The casing includes a facing surface that faces the cover, and at least one protrusion arranged to protrude from the facing surface toward the cover, so that the at least one protrusion abuts onto the cover to ensure electrical connection between the casing and the cover.

### CROSS-REFERENCE TO RELATED APPLICATION

This application is based on and claims the benefit of priority from earlier Japanese Patent Application No. 2023-086323 filed on May 25, 2023, the entire disclosure of which is incorporated herein by reference.

### TECHNICAL FIELD

The present disclosure relates to camera modules.

### BACKGROUND

A known imaging apparatus, which is disclosed in Japanese Patent Application Publication No. 2015-216444, includes an imaging optical unit, an electronic circuit unit, a case, a lid-shaped member, a fixing mechanism, and a shielding case. The case accommodates the imaging optical unit and the electronic circuit unit. The lid-shaped member closes an opening of the case. Each of the lid-shaped member and the case is made of resin. The lid-shaped member has a smooth abutting surface that abuts on an upper surface of the case. The fixing mechanism fixes the lid-shaped member to the case.

The fixing mechanism includes a bracket that applies pressing force to the lid-shaped member to accordingly cause the lid-shaped member to be in contact with the case. The bracket is made of metal, and includes a plurality of protruding portions. The protruding portions are pressed against the case so as to be stuck to the case, resulting in the bracket being fixed to any location within a predetermined movable range of the case in the direction of the abutting surface. The shielding case is provided around the electronic circuit unit inside the case while being formed in a box-like shape. The shielding case is accommodated in the case together with the electronic control unit while surrounding the electronic control unit. The shielding case is electrically connected to a portion of the electronic circuit unit; the portion has a reference potential, i.e., a ground potential. This enables the shielding case to ensure shielding performance.

### SUMMARY

Each of the lid-shaped member and the case of the imaging apparatus disclosed in the patent publication is made of a non-conductive material, such as resin, and therefore external electromagnetic noise is more likely to enter the imaging apparatus disclosed in the patent publication than a case where each of the lid-shaped member and the case of the imaging apparatus disclosed in the patent publication is made of metal. This may result in noise being likely to be generated in the electronic circuit unit. The imaging apparatus disclosed in the patent publication requires the shielding case separately from the lid-shaped member and the case, resulting in an increase in the number of components of the imaging apparatus.

In view of the circumstances set forth above, an aspect of the present disclosure seeks to provide camera modules, each of which is designed to have a simpler configuration and reduce external-noise impact on the corresponding one of the camera modules.

A first exemplary measure the present disclosure provides a camera module. The camera module includes a lens and a holder that accommodates the lens. The camera module includes an imaging device configured to capture an image based on light passing through the lens, and output a signal based on the captured image. The camera module includes a board configured to capture the signal outputted from the imaging device, a casing having electrical conductivity and joined to the holder, and a cover having electrical conductivity. The camera module includes at least one fastening member configured to fasten the casing and the cover to each other. An assembly of the casing and cover accommodates at least the imaging device and the board. The casing includes at least one abutment portion arranged to abut onto the cover while the cover is fastened to the casing by the at least one fastening member. The casing includes a facing surface that faces the cover, and at least one protrusion arranged to protrude from the facing surface toward the cover, so that the at least one protrusion abuts onto the cover to ensure electrical connection between the casing and the cover.

A second exemplary measure the present disclosure provides a camera module. The camera module includes a lens and a holder that accommodates the lens. The camera module includes an imaging device configured to capture an image based on light passing through the lens, and output a signal based on the captured image. The camera module includes a board configured to capture the signal outputted from the imaging device, a casing having electrical conductivity and joined to the holder, and a cover having electrical conductivity. The camera module includes at least one fastening member configured to fasten the casing and the cover to each other. An assembly of the casing and cover accommodates at least the imaging device and the board. The cover includes at least one abutment portion arranged to abut onto the casing while the cover is fastened to the casing by the at least one fastening member, and a facing surface that faces the casing. The cover includes at least one protrusion arranged to protrude from the facing surface toward the casing, so that the at least one protrusion abuts onto the casing to ensure electrical connection between the casing and the cover.

This configuration of the camera module according to each of the first and second exemplary measures makes smaller the intervals between electrical connection portions including the at least one protrusion and the at least one abutment portion as compared with a case where the casing and the cover are electrically connected without protrusions. This results in a resonance frequency of the camera module through the intervals between the electrical connection portions being higher. This is because a virtual space defined to extend from an inner hollow space of the casing through each smaller interval between the electrical connection portions becomes smaller. This results in a resonance wavelength being shorter in the virtual space, resulting in the resonance frequency in the virtual space being higher.

For this reason, setting a value of the resonance frequency to be higher than a predetermined frequency range in which cavity resonance is required to be prevented from occurring enables cavity resonance whose frequency is lower than or equal to the predetermined frequency range to be unlikely to occur within the camera module. This therefore reduces noise around the board due to the resonance frequency, thus reducing external-noise impact on the camera module while ensuring a simpler configuration of the camera module.

### BRIEF DESCRIPTION OF THE DRAWINGS

Other aspects of the present disclosure will become apparent from the following description of embodiments with reference to the accompanying drawings in which:

FIG. 1 is a cross-sectional view of a camera module according to the first embodiment;

FIG. 2 is a cross-sectional view taken along line II-II of FIG. 1;

FIG. 3 is a cross-sectional view taken alone line III-III of FIG. 2;

FIG. 4 is a cross-sectional view taken long line IV-IV of FIG. 2;

FIG. 5 is an enlarged view of a portion of FIG. 3, which is enclosed by a phantom block indicated by V;

FIG. 6 is a view taken in the direction of view indicated by VI in FIG. 5;

FIG. 7 is a cross-sectional view of a camera module according to the second embodiment;

FIG. 8 is a cross-sectional view of a camera module according to the third embodiment;

FIG. 9 is a cross-sectional view of a protrusion of a camera module according to the fourth embodiment; and

FIG. 10 is a cross-sectional view of a camera module according to the fifth embodiment.

### DETAILED DESCRIPTION OF EMBODIMENT

The following describes exemplary embodiments of the present disclosure with reference to the accompanying drawings.

Descriptions of components described in the exemplary embodiments, which are identical or equivalent to those described therein, may be omitted while, to each pair of the identical or equivalent components, the corresponding same reference character is assigned.

### First Embodiment

The following describes a camera module 10 according to the first embodiment. The camera module 10 according to the first embodiment has a simpler configuration that reduces electromagnetic noise from the outside of the camera module 10. The camera module 10 can be applied to unillustrated vehicles.

For example, the camera module 10 is applied to a vehicle, and is arranged adjacent to the front windshield. The camera module 10 is configured to capture images of the front view thereof. The camera module 10 is however not limited to such a front view camera, and can be used to capture images of at least part of the surrounding views, such as the left-side view, the right-side view, and/or the rear view.

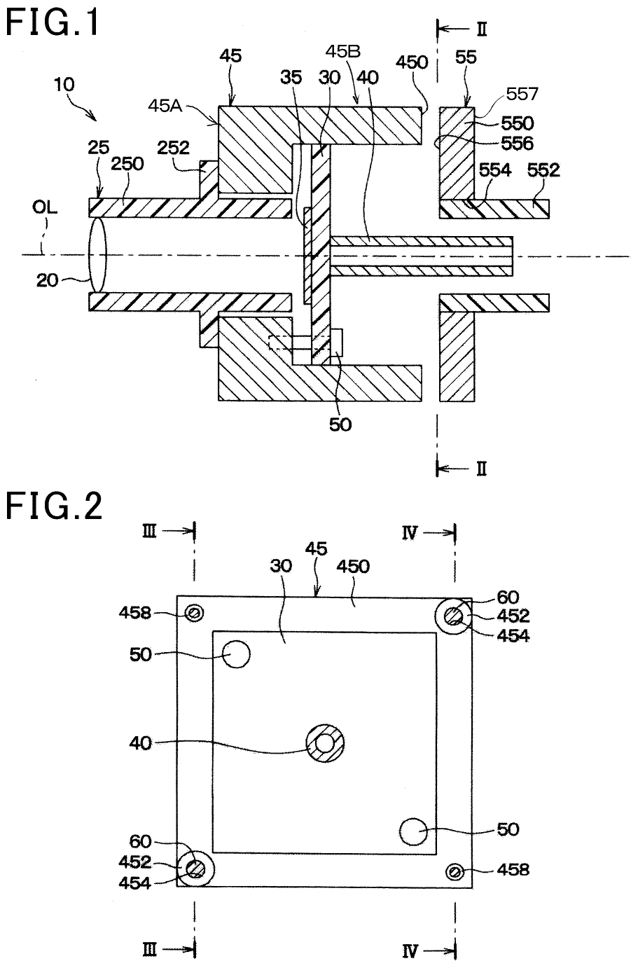

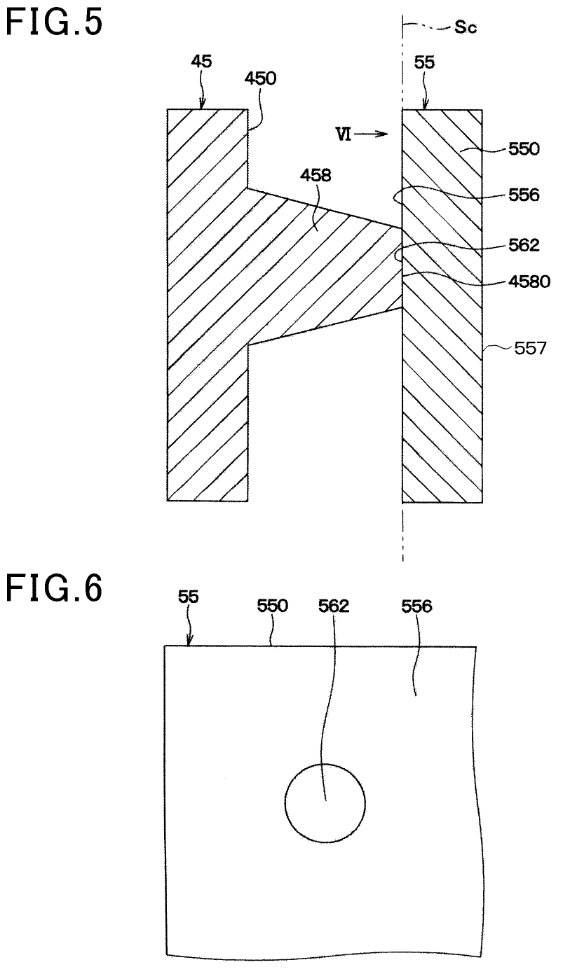

Specifically, the camera module 10 installed in a vehicle includes, as illustrated in FIGS. 1 to 6, a lens member 20, a holder 25, a board 30, an imaging device 35, a terminal 40, a casing 45, fastening members 50 for the board 30, a cover 55, and fastening members 60.

The lens member 20, which is comprised of one or more lenses, has an optical axis OL, and is arranged in the casing 45 while the optical axis OL extends in the longitudinal direction, i.e., front-rear direction, of the vehicle. The lens member 20 is configured to collect, as the base of a front-view image, light coming from the front of the vehicle.

The holder 25, which is made of, for example, resin, is comprised of a barrel 250 and a flange member 252. The barrel 250 has a substantially cylindrical tubular shape having a center axis; the barrel 250 is arranged in the casing 45 to extend with the center axis of the barrel 250 being coincident with the optical axis OL of the lens 20. That is, the barrel 250 accommodates the lens 20 therein while the optical axis OL of the lens 20 is coincident with the center axis of the barrel 250.

The board 30 is a printed-circuit board. The imaging device 35 is comprised of, for example, a semiconductor image sensor, such as a CMOS image sensor.

The board 30 has, for example, a two-dimensional plate-like shape, and has opposing first and second major surfaces. The board 30 is arranged in the casing 45 such that the first major surface is directed toward the front of the vehicle, and the second major surface is directed toward the rear of the vehicle. That is, the first major surface of the board 30 faces the lens member 20 in the optical axis OL. The imaging device 35 has a light-receiving surface, and is mounted on the first major surface of the board 30 such that the light-receiving surface of the imaging device 35 is directed to face the lens member 20.

The imaging device 35 is configured to perform an image capturing task of converting a light image of a front view focused by the lens member 20 on the light-receiving surface thereof into an electrical image, i.e., a captured image, to accordingly output the captured image to the board 30. The board 30 is configured to receive the captured image outputted from the imaging device 35.

That is, the imaging device 35 is configured to iterate the image capturing task to accordingly output the captured images to the board 30.

The terminal 40 is connected to the second major surface of the board 30. The board 30 is configured to output, to an unillustrated image processing apparatus through the terminal 40, the captured images outputted from the imaging device 35.

The image processing apparatus is operative to perform variable image-processing tasks based on the captured images outputted from the imaging device 35 and the board 30. For example, the image processing apparatus is configured to perform, as the image-processing tasks, a recognition task of recognizing, based on the captured images outputted from the imaging device 35 and the board 30, various traffic objects, such as traffic lanes, target objects, road configurations, obstacles, and/or traffic signs. The image processing apparatus is configured to output, to an unillustrated cruise assistance apparatus, the results of the image-processing tasks and the captured images.

The cruise assistance apparatus is configured to receive the results of the image-processing tasks and the captured images outputted from the image processing apparatus, and perform, based on the results of the image-processing tasks and the captured images, cruise assistance tasks including, for example,
1. A travel-assistance task of controlling braking of the vehicle and/or the steering of the vehicle to accordingly keep the vehicle within a target lane of a road in which the vehicle is traveling
2. A warning control task of controlling outputting of warning if it is determined that the vehicle is about to depart from the target lane

The board 30 can be configured to receive, through the terminal 40, operating power supplied from an unillustrated power supply installed in the vehicle.

The casing 45 is made of metal, such as aluminum, so that the casing 45 has electrical conductivity. The casing 45 has a quadrangular tubular shape, such as a rectangular tubular shape, extending in the direction of the optical axis OL to be coaxial with the barrel 250. The casing 45 accommodates the rear part of the holder 25, the board 30, and the terminal 40; the rear part of the holder 25 is located in the rear of the flange member 252. Specifically, the casing 45 is joined to the holder 25 while the rear part of the holder 25 is accommodated in the casing 45.

The casing 45 is comprised of a front wall 45A and a quadrangular tubular side wall, such as a rectangular tubular side wall, 45B. The front wall 45A has a quadrangular front surface and a quadrangular rear surface, and the quadrangular tubular side wall 45B extends in the rear direction from the outer edge of the front wall 45A.

The flange member 252 has opposing annular front and rear surfaces. The quadrangular front surface of the front wall of the casing 45 is, for example, adhered to the annular rear surface of the flange member 252 to be coaxial with each other, resulting in the rear part of the holder 25 being accommodated in the casing 45. The casing 45 and the flange member 252 of the holder 25 can be joined to one another with another means, such as bolts.

The fastening members 50 for the board 30 include, for example, two threaded bolts 50, and fasten the board 30 to the casing 45. For example, the front wall of the casing 45 has, for example, two threaded bottomed holes formed in the quadrangular rear surface thereof and located at respective two diagonal corners of the quadrangular rear surface. The board 30 has two through holes located at respective two diagonal corners thereof and formed therethrough. Each of the two threaded bottomed holes of the front wall of the casing 45 is aligned with the corresponding one of the two through holes of the board 30.

Threaded portions of the two threaded bolts 50 are threadably mounted in the respective two threaded bottomed holes of the front wall of the casing 45 through the respective two through holes of the board 30, resulting in the board 35 being secured to the casing 45.

The assembly of the casing 30 and the cover 55 are arranged to accommodate the rear part of the holder 25, the imaging device 35, the board 30, and the terminal 40. Specifically, the cover 55 includes a cover plate member 550 and a terminal housing 552.

The cover plate member 550 is made of metal, such as aluminum, so that the cover plate member 550 has electrical conductivity. The cover plate member 550 has a quadrangular tubular plate-like shape, and is arranged to extend in a direction perpendicular to the direction of the optical axis AL. Specifically, the cover plate member 550 has a quadrangular first major surface 556 and a second quadrangular major surface 557 opposite to the first major surface 556; the first major surface 556 of the cover plate member 550 serves as a covering facing surface 556 that faces the casing 45.

The cover plate member 550 includes a circular or quadrangular center hole 554 for arrangement of the terminal housing 552; the center hole 554 is located at the center of the cover plate member 550. The cover plate member 550 includes, for example, first and second recesses 558, and first and second cover holes 560.

The terminal housing 552 has a substantially circular or quadrangular tubular shape in conformity with the center hole 554, and is formed by, for example, insert molding of resin or other similar materials. A part, i.e., a front end, of the terminal housing 552 is tightly filled in the center hole 554 and secured to the cover plate member 550. The assembly of the casing 45 and the terminal housing 552 of the cover plate member 550 accommodates the terminal 40.

The second major surface 557 of the cover plate member 550 has a first pair of diagonal corners and a second pair of diagonal corners. The first and second recesses 558 are formed on the respective diagonal corners of the first pair so as to be recessed into the respective diagonal corners of the second major surface 557. That is, each of the first and second recesses 558 is concaved in the corresponding one of the diagonal corers of the first pair toward the casing 45. That is, the cover plate member 550 has a pair of recessed diagonal corners. The first and second cover holes 560 formed through the respective recessed diagonal corners of the cover plate member 550. That is, each of the first and second cover holes 560 is formed through the bottom of the corresponding one of the first and second recesses 558 and the covering facing surface 556 of the cover plate member 550.

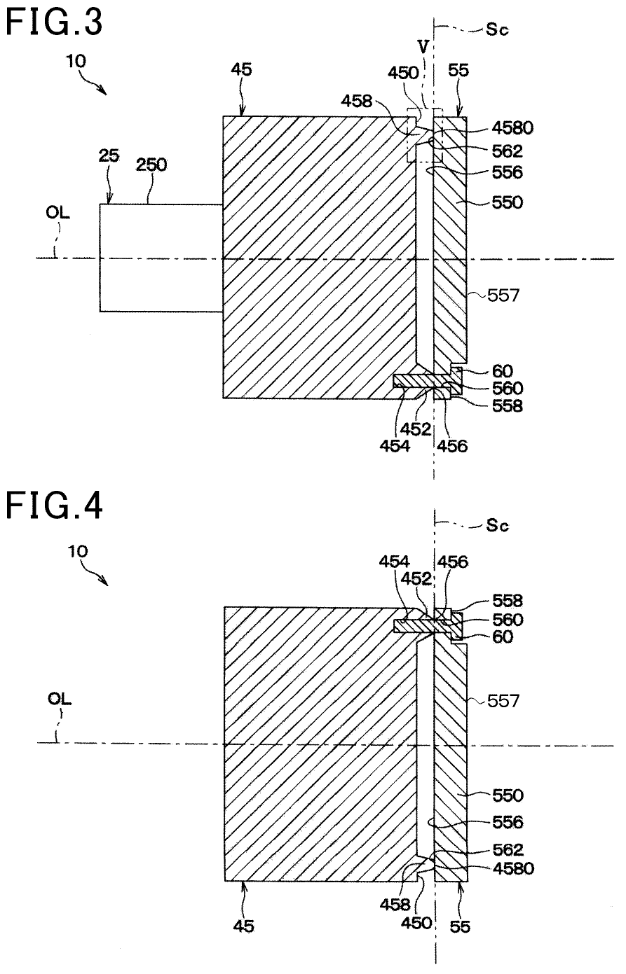

As illustrated in FIGS. 3 to 5, the casing 45 has a quadrangular ring-shaped facing surface 450 of the rear-side end of the tubular side wall 45B. The facing surface 450 has a first pair of diagonal corners and a second pair of diagonal corners.

As illustrated in FIGS. 3 to 5, the casing 45 includes first and second bosses 452, first and second threaded holes 454, first and second abutment portions 456, and first and second protrusions 458.

The facing surface 450 of the rear-side end of the tubular side wall 45B is arranged to face the cover 55 in the direction of the optical axis AL.

The first and second bosses 452 are formed on the respective diagonal corners of the first pair of the facing surface 450 to protrude toward the respective first and second recesses 558 of the cover plate member 550 of the cover 55.

The first and second threaded bottomed holes 454 are formed through (i) the respective first and second bosses 452 and (ii) the respective diagonal corners of the first pair of the facing surface 450 into the rear-side end of the tubular side wall 45B. Each of the first and second threaded bottomed holes 454 extends in the direction of the optical axis AL.

The first and second threaded bottomed holes 454 are communicably aligned with the respective first and second cover holes 560 of the cover plate member 550.

The fastening members 60 include, for example, first and second threaded bolts. Each of the first and second fastening members 60 is comprised of a base, such as a head, and a fastening portion, such as a threaded portion. The fastening portions of the first and second threaded members 60 are threadably mounted in the respective first and second threaded bottomed holes 454 through the respective first and second cover holes 560 of the cover plate member 550, resulting in the cover 55 being secured to the casing 45. While each of the first and second fastening members 60 is securely mounted in the corresponding one of the first and second threaded bottomed holes 454, the base of each of the first and second threaded members 60 is held in the corresponding one of the first and second recesses 558. This prevents the base of each of the first and second fastening members 60 from projecting outwardly from the cover 55, resulting in the first and second fastening members 60 being unlikely to abut the outer surface of the cover 55 and/or components located outside the cover 55. This therefore prevents the occurrence of damage due to contact between (i) the first and second fastening members 60 and (ii) both the cover 55 and the components located outside the cover 55.

The first and second abutment portions 456 are arranged to abut onto the covering facing surface 556 of the cover plate member 550 of the cover 55 while the cover 55 is secured to the casing 45 by the first and second fastening members 60. For example, the first boss 452 has an end that abuts onto a portion of the covering facing surface 556 around the first cover hole 560, and therefore the end of the first boss 452 serves as the first abutment portion 456. Similarly, the second boss 452 has an end that abuts onto a portion of the covering facing surface 556 around the second cover hole 560, and therefore the end of the second boss 452 serves as the second abutment portion 456.

The first and second protrusions 458 are formed on the respective diagonal corners of the second pair of the facing surface 450 to protrude toward the covering facing surface 556 of the cover plate member 550 of the cover 55, resulting in the first and second protrusions 458 abutting onto the covering facing surface 556 of the cover plate member 550 of the cover 55. This abutment between the first and second protrusions 458 and the covering facing surface 556 of the cover plate member 550 of the cover 55 ensures electrical conduction between the casing 45 and the cover 55. This therefore enables the assembly of the casing 45 and the cover 55 to ensure noise-shielding performance of the camera module 10. The noise-shielding performance of the camera module 10 is to reduce external electromagnetic-noise with respect to the camera module 10.

Each of the first and second protrusions 458 has an end 4580 that is in contact with the covering facing surface 556 of the cover plate member 550 of the cover 55. The end 4580 of each of the first and second protrusions 458 is formed as a planar shape.

Let us assume that (I) an imaginary stationary plane Sc is defined to pass through the first and second abutment portions 456 while being perpendicular to the optical axis OL, and (II) the end 4580 of each of the first and second protrusions 458 is located on the imaginary stationary plane Sc. The planar end 4580 of each of the first and second protrusions 458 enables the corresponding one of the first and second protrusions 458 to be likely to be in line or plane contact with the covering facing surface 556 of the cover plate member 550 of the cover 55. This therefore results in the casing 45 being likely to be electrically connected to the cover 55 through the first and second protrusions 458. The end 4580 of each of the first and second protrusions 458 is not limited to such a planar surface, and can be formed as a curved surface.

Each of the first and second protrusions 458 abuts onto the covering facing surface 556 of the cover plate member 550 of the cover 55 so as to be plastically deformed. Fastening of one of the casing 45 and the cover 55 to the other thereof brings force, which will be referred to as plastic deformation force, applied to each of the first and second protrusions 458 from the covering facing surface 556 of the cover plate member 550; the plastic deformation force causes each of the first and second protrusions 458 to be plastically deformed. This therefore results in (i) reaction force against the plastic deformation force applied to the first protrusion 458 being applied to the covering facing surface 556 of the cover plate member 550, and (ii) reaction force against the plastic deformation force applied to the second protrusion 458 being applied to the covering facing surface 556 of the cover plate member 550. This reaction force against the plastic deformation force applied to the first protrusion 458 forms a pressure mark 562 on a portion of the covering facing surface 556 of the cover plate member 550; the portion of the covering facing surface 556 is subjected to the reaction force against the plastic deformation force applied to the first protrusion 458. Similarly, this reaction force against the plastic deformation force applied to the second protrusion 458 forms a pressure mark 562 on a portion of the covering facing surface 556 of the cover plate member 550; the portion of the covering facing surface 556 is subjected to the reaction force against the plastic deformation force applied to the second protrusion 458.

Each of the first and second protrusions 458 has, for example, a circular truncated cone shape having smaller end plane and a larger base plane parallel to each other; the smaller end plane serves as the end 4580. Specifically, each of the first and second protrusions 458 has a tapered side peripheral surface extending from the larger base plane, which constitutes the facing surface 450, to the smaller end plane.

In other words, each of the first and second protrusions 458 has a diameter proportional to the direction from the larger base plane to the smaller end plane; the diameter becomes smaller from the larger base plane to the smaller end plane. Abutment of each of the first and second protrusions 458 onto the covering facing surface 556 of the cover plate member 550 therefore results in the corresponding one of the first and second protrusions 458 being likely to be plastically deformed.

The following describes how the camera module 10 of the first embodiment, which has the above simpler configuration set forth above, reduces external electromagnetic-noise impact on the camera module 10.

In the imaging apparatus disclosed in the patent publication described in the BACKGROUND, because each of the lid-shaped member and the case is made of a non-conductive material, such as resin, external electromagnetic noise may be more likely to enter the imaging apparatus as compared with a case where each of the lid-shaped member and the case is made of metal. This therefore may result in noise being likely to be generated in the electronic circuit unit. Additionally, the imaging apparatus disclosed in the patent publication requires a shield case in addition to the lid-shaped member and the case, resulting in an increase in the number of components of the imaging apparatus.

In contrast, the camera module 10 according to the first embodiment is comprised of the casing 45 and the cover 55, each of which has electrical conductivity. The casing 45 includes, as illustrated in FIGS. 3 to 5, the first and second abutment portions 456, the facing surface 450, and the first and second protrusions 458. The first and second abutment portions 456 are arranged to abut onto the covering facing surface 556 of the cover plate member 550 of the cover 55 based on fastening of the cover 55 to the casing 45 by the first and second fastening members 60. The facing surface 450 is arranged to face the cover 55. The first and second protrusions 458 are formed on the respective diagonal corners of the second pair of the facing surface 450 to protrude toward the covering facing surface 556 of the cover plate member 550 of the cover 55, resulting in the first and second protrusions 458 abutting onto the covering facing surface 556 of the cover plate member 550 of the cover 55. This abutment between the first and second protrusions 458 and the covering facing surface 556 of the cover plate member 550 of the cover 55 ensures electrical conduction between the casing 45 and the cover 55.

This configuration of the camera module 10 enables the assembly of the metallic casing 45 and the metallic cover 55 to efficiently ensure noise-shielding performance of the camera module 10 as compared with the imaging apparatus disclosed in the patent publication.

Additionally, the camera module 10 is configured to ensure four electrical connection portions of the casing 45 with respect to the cover 55; the four electrical connection portions include the first abutment portion 456, the second abutment portion 456, the first protrusion 458, and the second protrusion 458. This configuration therefore makes smaller the intervals between the four electrical connection portions as compared with a case where the casing 45 and the cover 55 are electrically connected without the first and second protrusions 458.

This results in a resonance frequency of the camera module 10 through the intervals between the four electrical connection portions being higher. This is because a virtual space defined to extend from an inner hollow space of the casing 45 through each smaller interval between the electrical connection portions becomes smaller. This results in a resonance wavelength being shorter in the virtual space, resulting in a resonance frequency in the virtual space being higher.

That is, the camera module 10 according to the exemplary embodiment is designed such that a value of the resonance frequency is higher than a predetermined frequency range in which cavity resonance is required to be prevented from occurring. This enables cavity resonance whose frequency is lower than or equal to the predetermined frequency range to be unlikely to occur within the camera module 10. This therefore reduces noise around the board 30, thus reducing external-noise impact on the camera module 10 while ensuring a simpler configuration of the camera module 10.

The simpler configuration of the camera module 10 reduces the number of components of the camera module 10, thus preventing an increase in size of the camera module 10. Preventing an increase in size of the camera module 10 improves the mountability of the camera module 10 in a vehicle equipped with many components, such as a rearview mirror, an Electronic Toll Collection System (ETC), various sensors including a rain sensor, and other components.

Additionally, the camera module 10 according to the first embodiment achieves the following advantageous benefits.

Specifically, the end 4580 of each of the first and second protrusions 458 is, as illustrated in FIGS. 3 and 4, located on the imaginary stationary plane Sc; the imaginary stationary plane Sc is defined to pass through the first and second abutment portions 456 while being perpendicular to the optical axis OL.

This configuration results in each of the first and second protrusions 458 being more likely to abut onto the covering facing surface 556 of the cover plate member 550 of the cover 55 during securing of one of the casing 45 and the cover 55 to the other thereof as compared with a case where the end 4580 of each of the first and second protrusions 458 is located to be closer to the casing 45 than each of the first and second abutment portions 456 is. This therefore results in the casing 45 being more likely to be electrically connected through the first and second protrusions 458 to the cover 55.

That is, this configuration ensures the four electrical connection portions of the casing 45 with respect to the cover 55; the four electrical connection portions include the first abutment portion 456, the second abutment portion 456, the first protrusion 458, and the second protrusion 458. This configuration therefore makes smaller the intervals between the four electrical connection portions as compared with a case where the casing 45 and the cover 55 are electrically connected without the first and second protrusions 458.

This results in a resonance frequency of the camera module 10 through the intervals between the four electrical connection portions being higher. This is because a virtual space defined to extend from an inner hollow space of the casing 45 through each smaller interval between the electrical connection portions becomes smaller. This results in a resonance wavelength being shorter in the virtual space, resulting in a resonance frequency in the virtual space being higher.

That is, the camera module 10 of the exemplary embodiment is designed such that a value of the resonance frequency is higher than the predetermined frequency range in which cavity resonance is required to be prevented from occurring. This enables cavity resonance whose resonance frequency is lower than or equal to the predetermined frequency range to be unlikely to occur within the camera module 10. This therefore reduces noise around the board 30, thus reducing external-noise impact on the camera module 10 while ensuring a simpler configuration of the camera module 10.

Additionally, fastening of one of the casing 45 and the cover 55 to the other thereof brings plastic deformation force applied to each of the first and second protrusions 458 from the covering facing surface 556 of the cover plate member 550; the plastic deformation force causes each of the first and second protrusions 458 to be plastically deformed. This therefore results in each of the first and second protrusions 458, while being plastically deformed, to strongly abut onto the covering facing surface 556 of the cover plate member 550 of the cover 55, enabling the casing 45 and the cover 55 to be likely to be electrically connected therebetween through the first and second protrusions 458.

The cover 55 has, as illustrated in FIGS. 3 to 6, the pressure marks 562, the shape of each of which is in conformity with the shape of the end 4580 of the corresponding one of the first and second protrusions 458.

This configuration means that each of the first and second protrusions 458, while being plastically deformed, strongly abuts onto the covering facing surface 556 of the cover plate member 550 of the cover 55 to the extent that the corresponding one of the pressure marks 562 is formed on the covering facing surface 556 of the cover plate member 550 of the cover 55. This therefore enables the casing 45 and the cover 55 to be more likely to be electrically connected therebetween through the first and second protrusions 458.

### Second Embodiment

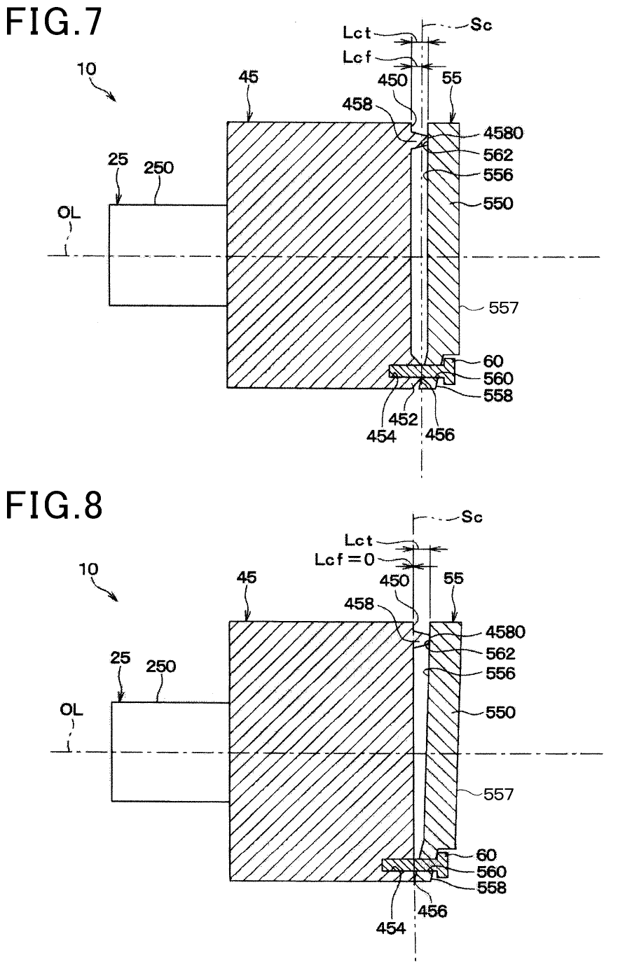

The following describes a camera module 10A according to the second embodiment of the present disclosure with reference to FIG. 7. The structure and/or functions of the camera module 10A according to the second embodiment are mainly identical to those of the camera module 10 except for the following points. The following therefore describes mainly the different points.

The end 4580 of each of the first and second protrusions 458 of the camera module 10 according to the first embodiment is located on the imaginary stationary plane Sc.

In contrast, the end 4580 of each of the first and second protrusions 458 of the camera module 10A according to the second embodiment is, as illustrated in FIG. 7, located to be closer to the cover 55 than the imaginary stationary plane Sc is. This configuration of the camera module 10A results in a length Lct defined between the facing surface 450 of the casing 45 and the end surface of each of the first and second protrusions 458 along the optical axis OL being longer than a length Lcf defined between the facing surface 450 of the casing 45 and the imaginary stationary plane Sc along the optical axis OL.

The configuration of the camera module 10A achieves, in addition to the above advantageous benefits achieved by the camera module 10, an advantageous benefit of increasing the level of plastic deformation of each of the first and second protrusions 458 to accordingly increase the level of abutment of each of the first and second protrusions 458 onto the covering facing surface 556 of the cover plate member 550.

### Third Embodiment

The following describes a camera module 10B according to the third embodiment of the present disclosure with reference to FIG. 8. The structure and/or functions of the camera module 10B according to the third embodiment are mainly identical to those of the camera module 10 except for the following points. The following therefore describes mainly the different points.

The casing 45 of the camera module 10 according to the first embodiment includes the first and second bosses 452.

In contrast, the casing 45 of the camera module 10B according to the third embodiment includes no first and second bosses 452. That is, each of the first and second abutment portions 456 is a portion of the corresponding one of the first pair of the facing surface 450, which abuts onto the covering facing surface 556 of the cover plate member 550. The length Lcf defined between the facing surface 450 of the casing 45 and the imaginary stationary plane Sc along the optical axis OL is therefore defined to be zero.

The camera module 10B of the third embodiment achieves substantially the same advantageous benefits achieved by the camera module 10 according to the first embodiment.

### Fourth Embodiment

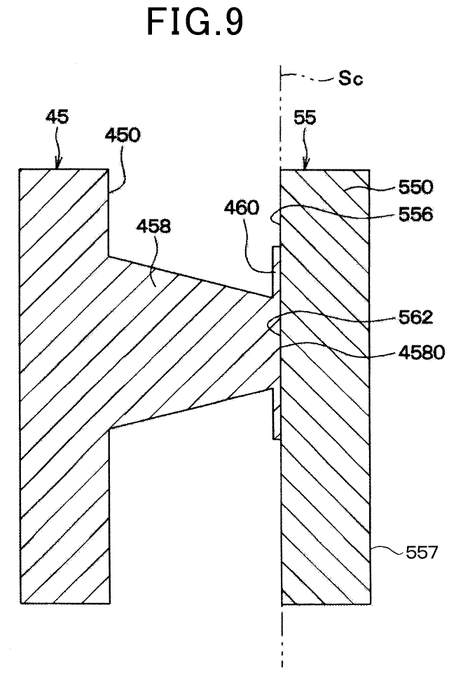

The following describes a camera module 10C according to the fourth embodiment of the present disclosure with reference to FIG. 9. The structure and/or functions of the camera module 10C according to the fourth embodiment are mainly identical to those of the camera module 10 except for the following points. The following therefore describes mainly the different points.

Each of the first and second protrusions 458 of the camera module 10C according to the fourth embodiment further includes a flange 460 formed around the end 4580 of the corresponding one of the first and second protrusions 458. The flange 460 of each of the first and second protrusions 458 is comprised of, for example, burrs formed by the plastic deformation of the corresponding one of the first and second protrusions 458. The flange 460 of each of the first and second protrusions 458 is, as illustrated in FIG. 9, arranged to extend from the end 4580 of the corresponding one of the first and second protrusions 458 in a direction perpendicular to the direction from the casing 45 to the cover 55, that is, in the direction perpendicular to the optical axis AL.

The camera module 10C of the fourth embodiment achieves substantially the same advantageous benefits achieved by the camera module 10 according to the first embodiment.

### Fifth Embodiment

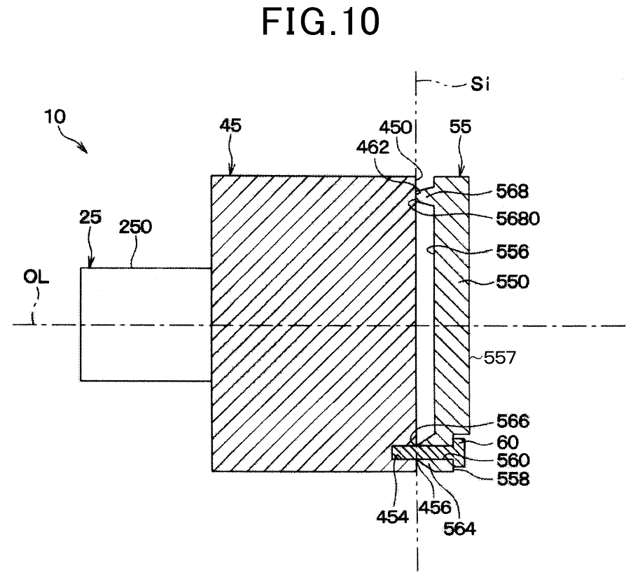

The following describes a camera module 10D according to the fifth embodiment of the present disclosure with reference to FIG. 10. The structure and/or functions of the camera module 10D according to the fifth embodiment are mainly identical to those of the camera module 10 except for the following points. The following therefore describes mainly the different points.

The casing 45 of the camera module 10 according to the first embodiment includes the facing surface 450, the first and second bosses 452, the first and second threaded holes 454, the first and second abutment portions 456, and the first and second protrusions 458.

In contrast, the casing 45 of the camera module 10D according to the fifth embodiment includes, as illustrated in FIG. 10, the facing surface 450, the first and second threaded holes 454, and the first and second abutment portions 456 without including the first and second bosses 452 and first and second protrusions 458.

Additionally, the configuration of each of the first and second threaded holes 454 and the first and second abutment portions 456 according to the fifth embodiment is different from that of the corresponding one of the first and second threaded holes 454 and the first and second abutment portions 456 according to the first embodiment.

In addition to the cover plate member 550 that has the center hole 554, the covering facing surface 556, the first and second recesses 558, and first and second cover holes 560, the cover 55 further includes first and second bosses 564, first and second abutment portions 566, and first and second protrusions 568. The configuration of each of the first and second cover holes 560 is different from that of the corresponding one of the first and second cover holes 560.

The first and second threaded bottomed holes 454 are formed through the respective diagonal corners of the first pair of the facing surface 450 into the rear-side end of the tubular side wall 45B. Each of the first and second threaded bottomed holes 454 extends in the direction of the optical axis AL.

Each of the first and second abutment portions 456 is, as described later, a portion of the corresponding one of the first pair of the facing surface 450, which abuts onto the corresponding one of the first and second bosses 564.

The first major surface, i.e., the facing surface, 556 of the cover plate member 550 has a first pair of diagonal corners and a second pair of diagonal corners.

The first and second bosses 564 are formed on the respective diagonal corners of the first pair of the facing surface 556 to protrude toward the respective diagonal corners of the first pair of the facing surface 450.

Each of the first and second cover holes 560 is formed through the corresponding one of the first and second bosses 564 and the bottom of the corresponding one of the first and second recesses 558.

The first and second protrusions 568 are formed on the respective diagonal corners of the second pair of the facing surface 560 to protrude toward the facing surface 450 of the casing 45, resulting in the first and second protrusions 568 abutting onto the facing surface 450 of the casing 45. This abutment between the first and second protrusions 568 and the facing surface 450 of the casing 45 ensures electrical conduction between the cover 55 and the casing 45. This therefore enables the assembly of the casing 45 and the cover 55 to ensure noise-shielding performance of the camera module 10D.

Each of the first and second protrusions 568 has an end 5680 that is in contact with the facing surface 450 of the casing 45. The end 5680 of each of the first and second protrusions 568 is formed as a planar surface.

Let us assume that an imaginary stationary plane Si is defined to pass through the first and second abutment portions 566 while being perpendicular to the optical axis OL.

In this assumption, the end 5680 of each of the first and second protrusions 568 is located on the imaginary stationary plane Si. The planar end 5680 of each of the first and second protrusions 568 enables the corresponding one of the first and second protrusions 568 to be likely to be in line or plane contact with the facing surface 450 of the casing 45. This therefore results in the casing 45 being likely to be electrically connected to the cover 55 through the first and second protrusions 568. The end 5680 of each of the first and second protrusions 568 is not limited to such a planar surface, and can be formed as a curved surface. The end 5680 of each of the first and second protrusions 568 can be located to be closer to the casing 45 than the imaginary stationary plane Si is.

Each of the first and second protrusions 568 abuts onto the facing surface 45 of the casing 45 so as to be plastically deformed. Fasting of one of the casing 45 and the cover 55 to the other thereof brings plastic deformation force applied to each of the first and second protrusions 568 from the facing surface 450 of the casing 45; the plastic deformation force causes each of the first and second protrusions 568 to be plastically deformed. This therefore results in (i) reaction force against the plastic deformation force applied to the first protrusion 568 being applied to the facing surface 450 of the casing 45, and (ii) reaction force against the plastic deformation force applied to the second protrusion 568 being applied to the facing surface 450 of the casing 45. This reaction force against the plastic deformation force applied to the first protrusion 568 forms a pressure mark 462 on a portion of the facing surface 450 of the casing 45; the portion of the facing surface 450 is subjected to the reaction force against the plastic deformation force applied to the first protrusion 568. Similarly, this reaction force against the plastic deformation force applied to the second protrusion 568 forms a pressure mark 462 on a portion of the facing surface 450 of the casing 45; the portion of the facing surface 450 is subjected to the reaction force against the plastic deformation force applied to the second protrusion 568.

Each of the first and second protrusions 568 has, for example, a circular truncated cone shape having smaller end plane and a larger base plane parallel to each other; the smaller end plane serves as the end 5680. Specifically, each of the first and second protrusions 568 has a tapered side peripheral surface extending from the larger base plane, which constitutes the covering facing surface 556, to the smaller end plane.

In other words, each of the first and second protrusions 568 has a diameter proportional to the direction from the larger base plane to the smaller end plane; the diameter becomes smaller from the larger base plane to the smaller end plane. Abutment of each of the first and second protrusions 568 onto the facing surface 450 of the casing 45 therefore results in the corresponding one of the first and second protrusions 568 being likely to be plastically deformed.

Like the fourth embodiment, each of the first and second protrusions 568 of the camera module 10D according to the fifth embodiment can further include a flange formed around the end 5680 of the corresponding one of the first and second protrusions 568. The flange of each of the first and second protrusions 568 is comprised of, for example, burrs formed by the plastic deformation of the corresponding one of the first and second protrusions 568. The flange of each of the first and second protrusions 568 is arranged to extend from the end 5680 of the corresponding one of the first and second protrusions 568 in a direction perpendicular to the direction from the cover 55 to the casing 45, that is, in the direction perpendicular to the optical axis AL.

The camera module 10D of the fifth embodiment achieves substantially the same advantageous benefits achieved by the camera module 10 according to the first embodiment.

The present disclosure is not limited to the first to fifth embodiments, and each of the first to fifth embodiment can be freely modified. One or more components in each of the first to fifth embodiments are not necessarily essential components except for (i) one or more components that are described as one or more essential components or (ii) one or more components that are essential in principle.

The control units and their control methods disclosed in the present disclosure can be implemented by a dedicated computer including a memory and a processor programmed to perform one or more functions embodied by one or more computer programs.

The control units and their control methods disclosed in the present disclosure can also be implemented by a dedicated computer including a processor comprised of one or more dedicated hardware logic circuits.

The control units and their control methods disclosed in the present disclosure can further be implemented by a processor system comprised of a memory, a processor programmed to perform one or more functions embodied by one or more computer programs, and one or more hardware logic circuits.

The one or more computer programs can be stored in a non-transitory storage medium as instructions to be carried out by a computer or a processor.

The camera modules 10, 10A, 10B, 10C, and 10D according to the respective embodiments are used for vehicles. The camera modules 10, 10A, 10B, 10C, and 10D are however not limited to other various uses including facilities.

The cruise assistance apparatus disclosed in each of the first to fifth embodiments is configured to perform, based on the results of the image-processing tasks and the captured images, the cruise assistance tasks including, for example, the travel-assistance task and the warning control task. The cruise assistance apparatus disclosed in each of the first to fifth embodiments can be configured to perform the cruise assistance tasks including, for example, the travel-assistance task and the warning control task in accordance with information acquired by Lidars installed in the vehicle in addition to the results of the image-processing tasks and the captured images. Lidars stand for Light Detection and Ranging/Laser Imaging Detection and Ranging.

The first and second protrusions 458 are integrally formed with the casing 45 according to each of the first to fourth embodiments. However, the first and second protrusions 458 can be formed separately from the casing 45. The casing 45 according to each of the first to fourth embodiments includes two protrusions as the first and second protrusions 458, but the number of protrusions is not limited thereto. Specifically, the casing 45 can include at least one protrusion.

Each of the first and second protrusions 458 according to each of the first to fourth embodiments has, for example, a circular truncated cone shape. However, each of the first and second protrusions 458 can have another shape, such as a polygonal prism shape or a hemispherical shape.

The first and second protrusions 568 are integrally formed with the cover 55 according to the fifth embodiment. However, the first and second protrusions 568 can be formed separately from the cover 55. The cover 55 according to the fifth embodiment includes two protrusions as the first and second protrusions 568, but the number of protrusions is not limited thereto. Specifically, the cover 55 can include at least one protrusion.

Each of the first and second protrusions 568 according to the fifth embodiment has, for example, a circular truncated cone shape. However, each of the first and second protrusions 568 can have another shape, such as a polygonal prism shape or a hemispherical shape.

The first to fifth embodiments can be freely combined with one another.

The present disclosure includes the following first to tenth technological concepts.

The first technological concept is a camera module (10). The camera module includes a lens (20), a holder (25) that accommodates the lens, and an imaging device (35) configured to capture an image based on light passing through the lens, and output a signal based on the captured image. The camera module includes a board (30) configured to capture the signal outputted from the imaging device, and a casing (45) having electrical conductivity and joined to the holder. The camera module includes a cover (55) having electrical conductivity, and at least one fastening member (60) configured to fasten the casing and the cover to each other. An assembly of the casing and cover accommodates at least the imaging device and the board. The casing includes at least one abutment portion (456) arranged to abut onto the cover while the cover is fastened to the casing by the at least one fastening member, and a facing surface (450) that faces the cover. The camera module includes at least one protrusion (458) arranged to protrude from the facing surface toward the cover, so that the at least one protrusion abuts onto the cover to ensure electrical connection between the casing and the cover.

In the second technological concept, which depends from the first technological concept, the at least one protrusion has an end (4580) that is in contact with the cover. The end of the at least one protrusion is located on an imaginary stationary plane (Sc). The imaginary stationary plane is defined to pass through the at least one abutment portion while being perpendicular to an optical axis (OL) of the lens.

In the third technological concept, which depends from the first technological concept, the at least one protrusion has an end (4580) that is in contact with the cover. The end of the at least one protrusion is located to be closer to the cover than an imaginary stationary plane Sc is. The imaginary stationary plane is defined to pass through the at least one abutment portion while being perpendicular to an optical axis (OL) of the lens.

In the fourth technological concept, which depends from any one of the first to third technological concepts, the at least one protrusion abuts onto the cover so as to be plastically deformed.

The fifth technological concept is a camera module (10). The camera module includes a lens (20), a holder (25) that accommodates the lens, and an imaging device (35) configured to capture an image based on light passing through the lens, and output a signal based on the captured image. The camera module includes a board (30) configured to capture the signal outputted from the imaging device, and a casing (45) having electrical conductivity and joined to the holder. The camera module includes a cover (55) having electrical conductivity, and at least one fastening member (60) configured to fasten the casing and the cover to each other. An assembly of the casing and cover accommodates at least the imaging device and the board. The cover includes at least one abutment portion (566) arranged to abut onto the casing while the cover is fastened to the casing by the at least one fastening member, and a facing surface (556) that faces the casing. The cover includes at least one protrusion (568) arranged to protrude from the facing surface toward the casing, so that the at least one protrusion abuts onto the casing to ensure electrical connection between the casing and the cover.

In the sixth technological concept, which depends from the fifth technological concept, the at least one protrusion has an end (5680) that is in contact with the casing. The end of the at least one protrusion is located on an imaginary stationary plane (Si). The imaginary stationary plane is defined to pass through the at least one abutment portion while being perpendicular to an optical axis (OL) of the lens.

In the seventh technological concept, which depends from the fifth technological concept, the at least one protrusion has an end (5680) that is in contact with the casing. The end of the at least one protrusion is located to be closer to the casing than an imaginary stationary plane (Si) is. The imaginary stationary plane is defined to pass through the at least one abutment portion while being perpendicular to an optical axis (OL) of the lens.

In the eighth technological concept, which depends from any one of the fifth to seventh technological concepts, the at least one protrusion abuts onto the casing so as to be plastically deformed.

In the ninth technological concept, which depends from any one of the first to fourth technological concepts, the cover has opposing first and second major surfaces (556, 557). The first major surface faces the facing surface of the casing. The cover has at least one recess (558) formed on at least one corner thereof so as to be recessed into the at least one corner. The at least one fastening member is mounted through the at least one recessed corner of the cover. A part of the at least one fastening member is held in the at least one recess.

In the tenth technological concept, which depends from any one of the fifth to eighth technological concepts, the cover has opposing first and second major surfaces (556, 557). The first major surface faces the facing surface of the casing. The cover has at least one recess (558) formed on at least one corner thereof so as to be recessed into the at least one corner. The at least one fastening member is mounted through the at least one recessed corner of the cover. A part of the at least one fastening member is held in the at least one recess.

1. A camera module comprising:
a lens;
a holder that accommodates the lens;
an imaging device configured to capture an image based on light passing through the lens, and output a signal based on the captured image;
a board configured to capture the signal outputted from the imaging device;
a casing having electrical conductivity and joined to the holder;
a cover having electrical conductivity; and
at least one fastening member configured to fasten the casing and the cover to each other, an assembly of the casing and cover accommodating at least the imaging device and the board,
the casing including:
at least one abutment portion arranged to abut onto the cover while the cover is fastened to the casing by the at least one fastening member;
a facing surface that faces the cover; and
at least one protrusion arranged to protrude from the facing surface toward the cover, so that the at least one protrusion abuts onto the cover to ensure electrical connection between the casing and the cover.

2. The camera module according to claim 1, wherein:
the at least one protrusion has an end that is in contact with the cover; and
the end of the at least one protrusion is located on an imaginary stationary plane, the imaginary stationary plane being defined to pass through the at least one abutment portion while being perpendicular to an optical axis of the lens.

3. The camera module according to claim 1, wherein:
the at least one protrusion has an end that is in contact with the cover; and
the end of the at least one protrusion is located to be closer to the cover than an imaginary stationary plane is, the imaginary stationary plane being defined to pass through the at least one abutment portion while being perpendicular to an optical axis of the lens.

4. The camera module according to claim 1, wherein:
the at least one protrusion abuts onto the cover so as to be plastically deformed.

5. A camera module comprising:
a lens;
a holder that accommodates the lens;
an imaging device configured to capture an image based on light passing through the lens, and output a signal based on the captured image;
a board configured to capture the signal outputted from the imaging device;
a casing having electrical conductivity and joined to the holder;
a cover having electrical conductivity; and
at least one fastening member configured to fasten the casing and the cover to each other, an assembly of the casing and cover accommodating at least the imaging device and the board,
the cover including:
at least one abutment portion arranged to abut onto the casing while the cover is fastened to the casing by the at least one fastening member;
a facing surface that faces the casing; and
at least one protrusion arranged to protrude from the facing surface toward the casing, so that the at least one protrusion abuts onto the casing to ensure electrical connection between the casing and the cover.

6. The camera module according to claim 5, wherein:
the at least one protrusion has an end that is in contact with the casing;
the end of the at least one protrusion is located on an imaginary stationary plane; and
the imaginary stationary plane is defined to pass through the at least one abutment portion while being perpendicular to an optical axis of the lens.

7. The camera module according to claim 5, wherein:
the at least one protrusion has an end that is in contact with the casing; and
the end of the at least one protrusion is located to be closer to the casing than an imaginary stationary plane is, the imaginary stationary plane being defined to pass through the at least one abutment portion while being perpendicular to an optical axis of the lens.

8. The camera module according to claim 5, wherein:
the at least one protrusion abuts onto the casing so as to be plastically deformed.

9. The camera module according to claim 1, wherein:
the cover has opposing first and second major surfaces;
the first major surface faces the facing surface of the casing;
the cover has at least one recess formed on at least one corner thereof so as to be recessed into the at least one corner;
the at least one fastening member is mounted through the at least one recessed corner of the cover; and
a part of the at least one fastening member is held in the at least one recess.

10. The camera module according to claim 5, wherein:
the cover has opposing first and second major surfaces;
the first major surface faces the facing surface of the casing;
the cover has at least one recess formed on at least one corner thereof so as to be recessed into the at least one corner;
the at least one fastening member is mounted through the at least one recessed corner of the cover; and
a part of the at least one fastening member is held in the at least one recess.
